(19) United States
(12) Patent Application Publication
(10) Pub. No.: US 2009/0310673 A1
(43) Pub. Date: Dec. 17, 2009

(54) METHOD AND APPARATUS FOR CONTROLLING A BITRATE IN A VIDEO PROCESSING SYSTEM

(75) Inventor: Chul CHUNG, Seoul (KR)

Correspondence Address: H.C. PARK & ASSOCIATES, PLC, 8500 LEESBURG PIKE, SUITE 7500, VIENNA, VA, 22182, US

(73) Assignee: Mondo Systems Co., Ltd., Seoul (KR)

(21) Appl. No.: 12/483,068

(22) Filed: Jun. 11, 2009

(30) Foreign Application Priority Data
Jun. 12, 2008 (KR) 10-2008-0055144

(51) Int. Cl. H04N 7/26

(52) U.S. Cl. 375/240.03; 375/240.02; 375/E07.132

(57) ABSTRACT

The present invention relates to a method and apparatus for controlling a bitrate used in video encoding to ensure quality of a targeted video in a video processing system. The apparatus may include a bitrate analyzer to determine a minimum bitrate satisfying a target video quality designated for each frame and/or scene, and an encoder to encode each frame using determined bitrates for each frame and/or scene.

The present invention discloses a bitrate control method that includes a process of determining the minimum bitrate satisfying the target quality designated for each frame or scene and a process of encoding each frame using the bitrate for each frame or scene determined above. A designated service quality can be produced by finding a unique bitrate that yields good video quality based on the complexity of each scene.

### CROSS REFERENCE TO RELATED APPLICATION

This application claims priority from and the benefit of Korean Patent Application No. 10-2008-0055144, filed on Jun. 12, 2008, which is hereby incorporated by reference for all purposes as if fully set forth herein.

### BACKGROUND OF THE INVENTION

1. Field of the Invention

Embodiments of the present invention relate to an apparatus and method for encoding video data in a video processing system. In particular, exemplary embodiments of the present invention relate to controlling a bitrate of an encoded video to obtain a designated quality of a targeted video.

2. Description of the Background

In general, videos and images may be encoded to ensure that the videos and images are output in a desired format. However, bitrates used while encoding may vary depending on the type of video input resulting in inconsistent output videos. Thus, bitrates must be controlled to replace irregularly produced data with high quality consistent data and to keep regular transmission speed.

In an encoding method of MPEG models, a volume of bitrates produced by each frame of a video may be determined according to the video quality and contents. For example, a higher quality video produces a larger volume of data, and a lower quality video produces a smaller volume of data. If contents of the video become more complex, the volume of data becomes bigger, and if contents of the video become less complex, the volume of data becomes smaller. Various methods to control the video quality and data volume of a particular frame may be used including a method in which a Quantization Parameter (QP) may be controlled. For example, if a frame is encoded at a lower QP, the video quality may be better, and if a frame is encoded at a higher QP, the video quality may be worse. The QP can indicate the relative tradeoff between video quality and data volume, but cannot be an absolute quality measuring value. If two different videos are encoded at the same QP, the two videos may still not have the same video quality.

Currently, there are several encoding technologies utilized to control QP, including CBR (Constant Bit Rate) and VBR (Variable Bit Rate). CBR and VBR can provide relatively constant video quality of each video sequence within the given bitrate, but do not achieve an absolute level of video quality.

Compression methods of most MPEG models are focused on encoding video data at the designated target bitrate. Thus, if the target bitrate is used, a specific level of video quality may be maintained. In some cases though, a higher bitrate can be used if a low complexity video needs to be encoded.

### SUMMARY OF THE INVENTION

Exemplary embodiments of the present invention provide an apparatus and method for controlling a bitrate in a video processing system.

Exemplary embodiments of the present invention further provide an apparatus and method for achieving a minimum bitrate and good service quality in a video processing system.

Additional features of the exemplary embodiments will be set forth in the description which follows, and in part will be apparent from the description, or may be learned by practice of the invention.

An exemplary embodiment of the present invention discloses an apparatus comprising a bitrate analyzer and an encoder. The bitrate analyzer determines a minimum bitrate corresponding to a target video quality of a frame in a scene and/or the scene in an input video. The encoder encodes the frame and/or the scene at the bitrate determined by the bitrate analyzer.

An exemplary embodiment of the present invention discloses a method to control the bitrate of an input video. The method comprises determining a minimum bitrate that satisfies a target video quality of a frame or a scene of the input video and encoding the frame using the determined bitrate of the frame or the scene.

It is to be understood that both the foregoing general description and the following detailed description are exemplary and explanatory and are intended to provide further explanation of the invention as claimed.

### BRIEF DESCRIPTION OF DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a graph illustrating a correlation between bitrate and video quality according to some exemplary embodiments of the invention.

FIG. 2 illustrates a block diagram of a bitrate control device 200 according to some exemplary embodiments of the present invention.

FIG. 3 is a flow chart indicating the bitrate control method in the bitrate control device 200 according to some exemplary embodiments of the present invention.

FIG. 4 illustrates a block drawing of the bitrate control device 400 according to some exemplary embodiments of the present invention.

FIG. 5 is a flow chart indicating the bitrate control method according to some exemplary embodiments of the present invention.

FIG. 6 is a graph indicating a Rate-Distortion (R-D) curve according to some exemplary embodiments of the present invention.

### DETAILED DESCRIPTION OF THE ILLUSTRATED EMBODIMENTS

Embodiments of the present invention are described more fully hereinafter with reference to the accompanying drawings in which exemplary embodiments of the invention are illustrated. Embodiments of the invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the sizes and relative sizes of layers and regions may be exaggerated for clarity. Detailed descriptions of well-known functions and structures incorporated herein may be omitted to avoid obscuring the subject matter of the embodiments. Like reference numerals in the drawings denote like elements.

It will be understood that although the terms first, second, third etc. may be used herein to describe various elements, components, regions, layers and/or sections, these elements, components, regions, layers and/or sections should not be limited by these terms. These terms are used to distinguish one element, component, region, layer or section from another element, component, region, layer or section. A first element, component, region, layer or section discussed below could be termed a second element, component, region, layer or section without departing from the teachings of the present invention.

The terminology used herein is for the purpose of describing particular example embodiments and is not intended to be limiting of the present invention. As used herein, the singular forms “a,” “an” and “the” can include the plural forms as well, unless the context clearly indicates otherwise. It will be further understood that the terms “comprises” and/or “comprising,” when used in this specification, can specify the presence of stated features, integers, steps, operations, elements, and/or components, but do not necessarily preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Prior to describing exemplary embodiments of the present invention, relevant terms will be defined for the present description below.

“Scene” is a set of frames whose designated inherent bitrate is maintained in a relatively constant manner. For example, in compression methods of MPEG models, a scene is composed of a single GOP (Group of Picture), several GOP's, or simply a set of one or more frames.

Hereinafter, exemplary embodiments of the present invention will be explained in detail with reference to the accompanying drawings.

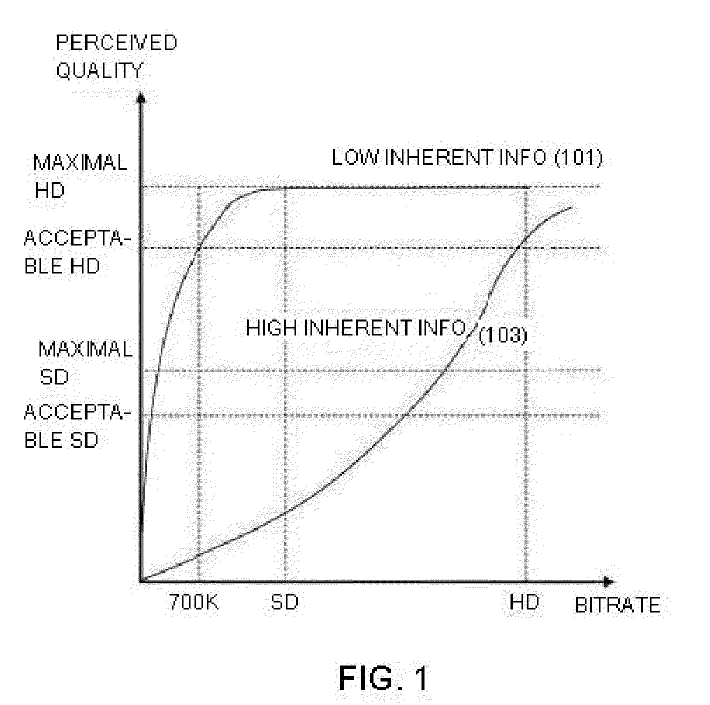

FIG. 1 is a graph illustrating a correlation between bitrate and video quality according to some exemplary embodiments of the invention. The horizontal axis indicates bitrate, and the vertical axis indicates perceived video quality.

As shown in FIG. 1, different bitrate values may be needed for different data volumes to obtain the same video quality in High Definition (HD) or Standard Definition (SD). For example, in the case of Low Inherent Information 101 in HD video quality, a minimum 700 k/bps bitrate may be allocated to obtain HD class video quality. Allocating a bitrate larger than 700 k/bps may be an unnecessary waste of data, since humans can not perceive the difference. In the case of High Inherent Information 103, a bitrate in the HD class video quality (e.g., larger than 700 k/bps) may be allocated to ensure HD class video quality.

A minimum bitrate may be used to ensure service quality by finding an inherent bitrate and encoding the video with the inherent bitrate. The inherent bit rate may be indicative of a saturation point of video quality or a bitrate beyond which video quality may not improve. The inherent bitrate may vary depending on the contents of the video.

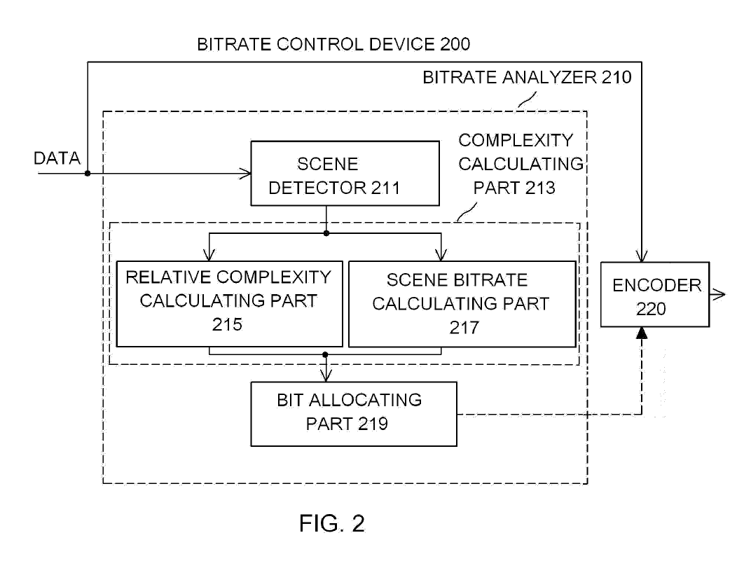

FIG. 2 illustrates a block diagram of a bitrate control device 200 according to some exemplary embodiments of the present invention.

As shown in FIG. 2, the bitrate control device 200 may include a bitrate analyzer 210 and an encoder 220. It should be understood that the bitrate control device 200 may have additional components, but only certain components are shown in FIG. 2 for convenience of explanation.

The bitrate analyzer 210 may determine a minimum bitrate of an input video having one or more scenes. The minimum bitrate may satisfy a given target video quality of each frame. The bitrate analyzer 210 may calculate a bitrate for each frame and/or scene. The encoder 210 may encode input video data using a calculated bitrate.

To calculate a bitrate for each frame and ensure target video quality, the bitrate analyzer 210 may include a scene detector 211, a complexity calculating part 213, and a bit allocating part 219.

The scene detector 211 may detect scenes using scene cut of the input video. The scene cut can be implemented by mean of absolute differences (MAD) or, in general, any other suitable method. MAD may be described as follows. Firstly, a movement of an i^{th} frame may be compensated, and then an average of absolute values of a difference between an (i−1)^{st} frame and each pixel may be calculated. A scene may be cut by recognizing a change of scenes at a point having the greatest value of MAD.

The complexity calculating part 213 may calculate the relative complexity of each frame in each scene detected by the scene detector 211 and a target bitrate of an entire/total scene. The complexity calculating part 213 may perform calculations using the relative complexity calculating part 215 and a scene bitrate calculating part 217. The relative complexity calculating part 215 may calculate the relative complexity of each frame by encoding scenes at a certain QP. The relative complexity of an i^{th} frame of the g^{th} scene (c_{g,i}) can be calculated using the following <Mathematical Formula 1>.

c_{g,i}=(R_{g,i}−H_{g,i})/( R̅_̅{̅g̅}̅−̅H̅_̅{̅g̅}̅)+MV_{(g,i)}/ M̅V̅_̅{̅g̅}̅ <Mathematical Formula 1>

The “R_{g,i}” and “H_{g,i}” represent a resulting bitrate of encoding and a bitrate of header of the i^{th} frame of scene g, respectively. MV(g,i) represents a bitrate of a motion vector of the i^{th} frame. “ M̅V̅_̅{̅g̅}̅” and “ R̅_̅{̅g̅}̅−̅H̅_̅{̅g̅}̅” represent an average bitrate of motion vector and an average bitrate of a total scene g excluding the header, respectively.

As can be appreciated from <Mathematical Formula 1>, the relative complexity has no relationship with QP. Thus, the QP used in the complexity calculating part 213 may be the same QP used in the encoder 220 or could be another QP. The encoding can be performed by an encoder (not indicated in the drawing) equipped in the complexity calculating part 213 or the encoder 220 shown in FIG. 2.

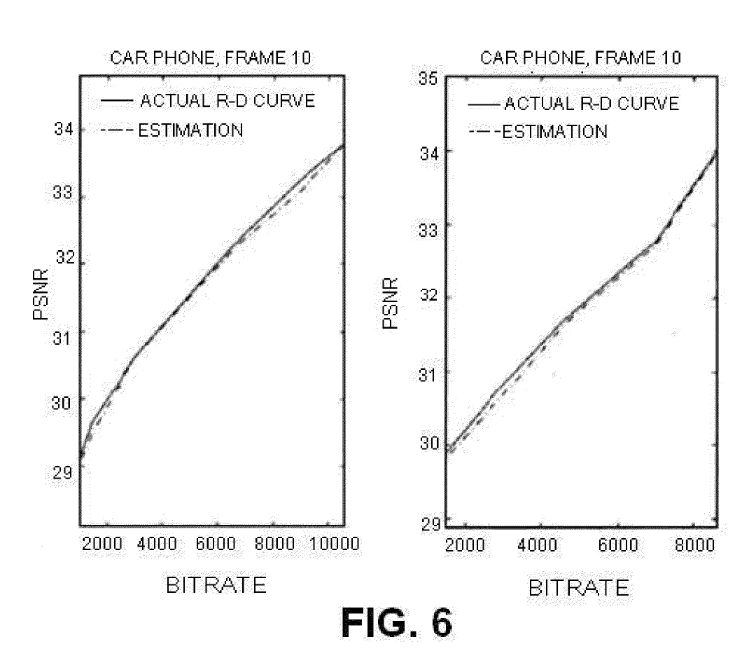

The scene bitrate calculating part 217 may calculate the bitrate allocated to the total scene. The bitrate allocated to the total scene can be obtained by using a Rate-Distortion (R-D) curve illustrated, for example, in FIG. 6, and the bitrate corresponding to the target video quality using a Peak Signal-To-Noise Ratio (PSNR) or Mean Squared Error (MSE). The R-D Curve may indicate differences between an original frame and an encoded frame. In some cases, the R-D curve may be estimated based on a result of encoding representative frames of the scene at several predetermined QPs. Estimation of R-D Curves is well-known in the art and a detailed explanation will therefore not be provided herein.

Once a R-D Curve is obtained, a bitrate corresponding to a certain video quality, for example, PSNR=‘32’, may be obtained.

The relative complexity per frame does not indicate an absolute value. Therefore, after determining the c_{g,i} of each frame and obtaining the bitrate of a scene g, the bitrate to be allocated to each frame in the scene may be obtained using the following <Mathematical Formula 2>.

BR_{g,i}=C_{g,i}/N_{g}*BR_{g} <Mathematical Formula 2>

Here, BR_{g,i} represents the bitrate allocated to frame i, N_{g} represents a number of frames in scene g, and BR_{g} represents the bitrate allocated to total scene g.

The above bit allocating part 219 may calculate the bitrate of each frame using <Mathematical Formula 2> after obtaining the relative complexity of each frame and the bitrate of total scene from the complexity calculating part 213. After that, the bit allocating part 219 may transfer the calculated bitrate to the encoder 220. The encoder 220 may encode using the calculated bitrate of each frame.

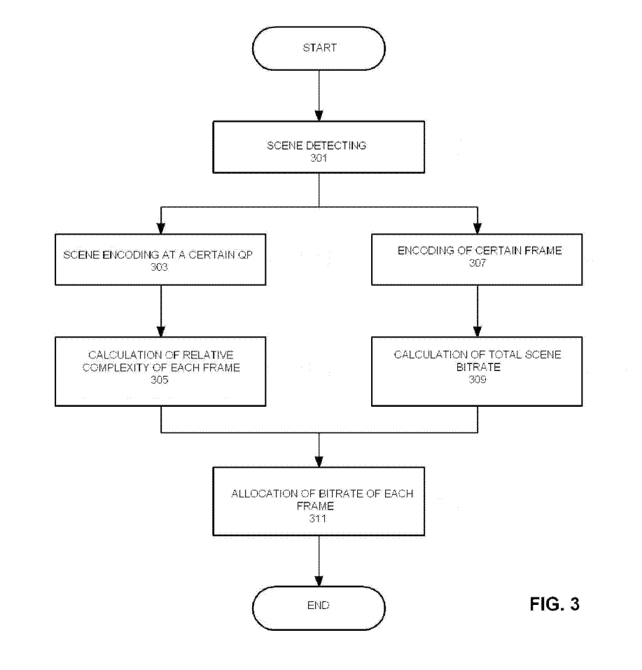

FIG. 3 is a flow chart indicating the bitrate control method in the bitrate control device 200 according to some exemplary embodiments of the present invention.

As shown in FIG. 3, a scene detector 211 in the bitrate control device 200 may detect 301 scenes using scene cut. Scene cut can be detected by MAD or any other suitable method.

Subsequently, the bitrate control device 200 may calculate the relative complexity of detected scenes and the bitrate of the total scene. The calculation may be done separately or simultaneously. The relative complexity calculating part 215 may encode 303 the detected scenes at a certain QP, and may calculate 305 the relative complexity of each frame. The relative complexity of each frame may be calculated using <Mathematical Formula 1>.

The scene bitrate calculating part 217 may also encode 307 using a certain bitrate. The scene bitrate calculating part 217 may perform preliminary encodings using several bitrates to estimate the R-D Curve. The scene bitrate calculating part 217 may then calculate 309 the target bitrate of the total scene using the estimated R-D Curve.

When the relative complexity and the bitrate of the total scene are calculated, the bit allocating part 219 can provide the target video quality by allocating 311 the bitrate of each frame calculated by <Mathematical Formula 2> to the encoder 220.

In the foregoing, encoding may be performed after detecting scenes and calculating the bitrate of each scene without calculating the bitrate of each frame corresponding to the target video quality.

However, in some exemplary embodiments, the scene bitrate calculating part 213 may calculate the bitrate of each scene by encoding the scenes input from the scene detector 211 at a certain QP, and subsequently the encoder 220 may encode a certain frame using the calculated bitrate. Furthermore, the bitrates of a scene may be allocated based on an estimated complexity of each frame without encoding. The complexity of a frame can be calculated by combining the complexities of macro blocks comprising each frame. The complexity of frame can be calculated by the following <Mathematical Formula 3>.

c=Σwₑ(edge(x,y))*wₘ(MV) <Mathematical Formula 3>

Here, “(x,y)” represents a location of a pixel within a relevant macro block; “edge(x,y)” represents a certain edge strength of a relevant pixel calculated by edge detector; “wₑ” represents an experiential weighted value of edge strength; “MV” represents the average motion vector size of the relevant macro block; and “wₘ” represents an experiential weighted value of motion vector size.

In the foregoing, encoding may be performed according to objective video quality like PSNR or MSE and therefore the video quality may not reflect a subjective video quality based on a visual preference of a human being. In the following exemplary embodiments, a more accurate bitrate may be used. The more accurate bitrate may be obtained in an iterative manner by calculating a bitrate until the bitrate satisfies a certain condition of subjective video quality calculated per each input scene.

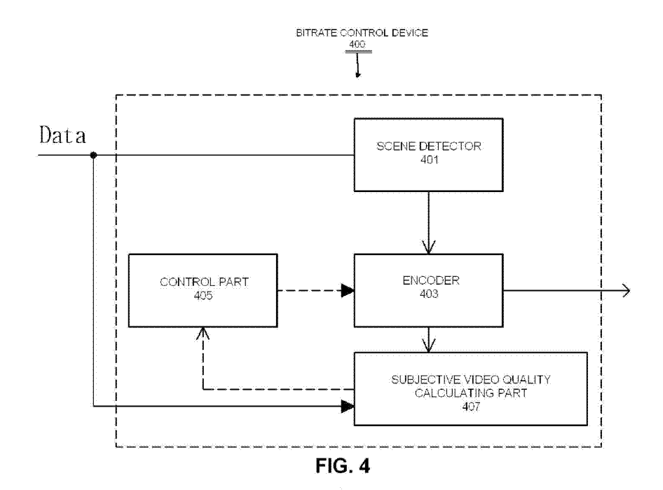

FIG. 4 illustrates a block drawing of the bitrate control device 400 according to some exemplary embodiments of the present invention.

As shown in FIG. 4, a bitrate control device 400 may include a scene detector 401, an encoder 403, a control part 405, and a subjective quality calculating part 407.

The scene detector 401 may detect a change of scenes in the input video. The scenes can be detected by MAD or, in general, any other suitable method. The encoder 403 may encode scenes output from the scene detector 401 firstly at a certain bitrate, and then, at the bitrate specified by the control part 405. The subjective quality calculating part 407 can measure a subjective video quality of encoded scenes by using a metric indicating a video quality that may be visually perceived by a human being. In general, any suitable metric indicating the subjective video quality may be used. For example, a metric that measures subjective visual quality of the encoded video compared to the quality of the original input video may be used. The subjective video quality may be output from 0% to 100%.

The control part 405 may control the bitrate of the encoder 403 by comparing the video quality of the subjective quality calculating part 407 and the pre-determined standard video quality. For example, if the standard video quality is set at 80%-90%, the encoder 403 may encode using a bitrate increased or decreased by a determined volume if the subjective video quality encoded at a certain bitrate becomes below 80% or over 90%.

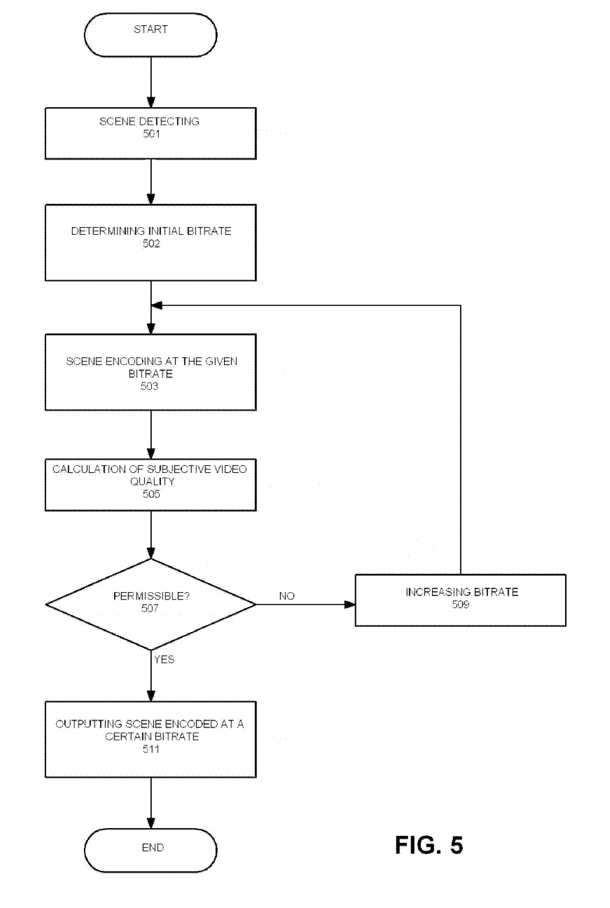

FIG. 5 is a flow chart indicating the bitrate control method of the bitrate control device 400 according to exemplary embodiments of the present invention.

As shown in FIG. 5, the scene detector 401 may detect 501 the change of scenes using MAD or any other suitable method. An initial bitrate may be determined 502 using any of the bitrate determining methods described herein, or in general, any suitable method, and the encoder 403 may then encode 503 the detected scenes at a certain bitrate.

Next, the subjective quality calculating part 407 may calculate 505 the subjective video quality of the encoded scenes at a certain bitrate. The subjective video quality can be measured using the metric discussed above, or, in general, any other suitable metric indicating subjective video quality.

The control part 405 may check 507 whether a difference between the calculated subjective video quality and the pre-determined standard quality is acceptable. If the calculated subjective video quality calculated is below or above the standard, the control part 405 may proceed to increase or decrease 509 a certain volume of bitrate, and may encode the detected scenes at a certain bitrate as in 503. The subjective video quality may then again be calculated 505 and checked until the calculated subjective quality satisfies the standard. Steps 503 and 507 may be repeated one or more times. If the subjective video quality, which may be calculated through repeated 503 and 507 stages, becomes the video quality within the standard, the scenes encoded at the certain bitrate, may be output 511.

It will be apparent to those skilled in the art that various modifications and variation can be made in the present invention without departing from the spirit or scope of the invention. Thus, it is intended that exemplary embodiments of the present invention cover the modifications and variations of this invention provided they come within the scope of the appended claims and their equivalents.

What is claimed is:

1. An apparatus, comprising:
a bitrate analyzer to determine a minimum bitrate corresponding to a target video quality of a frame in a scene and/or the scene in an input video; and
an encoder to encode the frame and/or the scene at the bitrate determined by the bitrate analyzer.

2. The apparatus of claim 1, wherein the bitrate analyzer comprises:
a scene detector to detect the scene using a scene cut of the input video;
a complexity calculating part to calculate a complexity of the frame in the scene; and
a bit allocating part to determine the bitrate of the frame based on a resulting value calculated by the complexity calculating part.

3. The apparatus of claim 2, wherein the complexity calculating part comprises:
a relative complexity calculating part to calculate a relative complexity of each frame in the scene; and
a scene bitrate calculating part to calculate the bitrate corresponding to the target video quality of the scene, and
wherein the bit allocating part determines the bitrate of each frame using the relative complexity of each frame and the bitrate.

4. The apparatus of claim 3, wherein the complexity calculating part calculates the relative complexity of each frame after encoding the scene using a quantization parameter, and wherein the scene bitrate calculating part calculates the bitrate corresponding to the target video quality of the scene using a rate-distortion curve calculated by encoding the scene at one or more quantization parameters.

5. The apparatus of claim 2, wherein the complexity calculating part estimates the complexity from a pixel value of the frame.

6. The apparatus of claim 1, wherein the bitrate analyzer comprises:
a scene detector to detect the scene using a scene cut of the input video;
a scene bitrate calculating part to calculate the bitrate corresponding to the target video quality of the scene; and
an encoder to encode each frame in the scene using the bitrate.

7. The apparatus of claim 1, wherein the bitrate analyzer comprises:
a scene detector to detect the scene by detecting a change in the input video;
a relative quality calculating part to measure a relative video quality, the relative video quality comparing an original uncoded scene of the input video to the scene encoded by the encoder at the bitrate; and
a control part to modify the designated bitrate if the relative video quality does not satisfy a designated standard quality.

8. A method for controlling the bitrate of an input video, comprising:
determining a minimum bitrate satisfying a target video quality of a frame or a scene of the input video; and
encoding the frame and/or the scene using the determined bitrate of the frame and/or the scene.

9. The method of claim 8, wherein determining a minimum bitrate comprises:
detecting the scene using scene cut of the input video;
calculating a complexity of the frame; and
determining the bitrate of the frame based on the calculated complexity.

10. The method of claim 9, wherein calculating a complexity comprises:
calculating a relative complexity of each frame in the scene;
calculating a scene bitrate allocated to the scene, the scene bitrate corresponding to the target video quality; and
determining the bitrate of each frame using the relative complexity of each frame and the scene bitrate.

11. The method of claim 10, wherein the relative complexity of each frame is calculated after encoding the scene at a quantization parameter, and the scene bitrate is calculated after creating a rate-distortion curve through encoding the scene at one or more quantization parameters.

12. The method of claim 9, wherein the calculating comprises directly estimating, using video treatment, a complexity from a pixel value of the input video.

13. The method of claim 9, wherein the detecting comprises:
calculating the bitrate of the detected scene; and
encoding each frame using the bitrate.

14. The method of claim 8, wherein the detecting comprises:
detecting the scene by finding a change in the input video;
measuring a relative video quality, the relative video quality comparing an original uncoded scene of the input video to the scene encoded by the encoder at the bitrate;
modifying the bitrate if the relative video quality does not satisfy a pre-determined standard video quality; and
outputting the encoded scene if, after modifying the bitrate, the relative video quality satisfies the pre-determined standard video quality.
